(19) United States
(12) Patent Application Publication
(10) Pub. No.: US 2018/0293215 A1
(43) Pub. Date: Oct. 11, 2018

(54) Method and Computer Program for Sharing Memo between Electronic Documents

(71) Applicant: Jeong Hui Jang, Boryeong-si (KR)

(72) Inventor: Jeong Hui Jang, Boryeong-si (KR)

(21) Appl. No.: 15/808,903

(22) Filed: Nov. 10, 2017

(30) Foreign Application Priority Data
Apr. 10, 2017 (KR) 10-2017-0046082

(51) Int. Cl. G06F 17/24; G06F 17/21; G06F 17/27; G06F 3/0481

(52) U.S. Cl. CPC G06F 17/241; G06F 17/218; G06F 3/0481; G06F 17/2795; G06F 17/2765

(57) ABSTRACT

Disclosed is a method, a system and a computer program for sharing a memo between electronic documents. According to the present invention, when a memo is created in a specific area of a specific electronic document, a keyword set is configured by extracting keywords from a corresponding area, and a user memo is stored in a corresponding keyword set, and if the keyword set has high similarity to a keyword set in which the keywords extracted from a paragraph, a sub-paragraph, a context or the like of another document are included, contents of the memo previously stored in the keyword set may be shown in another document.

### CROSS REFERENCE TO RELATED APPLICATION

The present application claims the benefit of Korean Patent Application No. 10-2017-0046082 filed in the Korean Intellectual Property Office on Apr. 10, 2017, the entire contents of which are incorporated herein by reference.

### BACKGROUND OF THE INVENTION

### Field of the Invention

The present invention relates to a method of sharing a memo between electronic documents, and more specifically, to a method and system for providing contents of a memo created for a specific area of an electronic document in another area of the same electronic document or in another electronic document.

### Background of the Related Art

Conventionally, when a memo is created on an electronic document, the memo is stored on the basis of a fixed position on the electronic document, such as a specific page, a specific sentence or the like of the document.

Accordingly, although a specific context or meaning unit similar to that of a memo created before appears again in another electronic document, the user cannot see the memo created before.

Likewise, although a context or a meaning unit the same as that of a memo previously created at a different position of the same electronic document which has created the memo before appears again, the memo created before cannot be shown again.

Particularly, since the modern society is a knowledge information society overflowing with numerous information, reading again a document that has been read before is uneconomical since opportunity cost of time should be paid, and therefore, the cases of reading again a document read before are decreased.

Accordingly, since a chance of seeing again a memo stored at a specific position of a certain document is decreased, utilization of taking a memo on an electronic document itself is lowered.

### SUMMARY OF THE INVENTION

The present invention has been made in view of the above problems, and it is an object of the present invention to provide a method of sharing a memo between electronic documents, in which if a memo is created and stored for a specific area of an electronic document and when a similar specific context or meaning unit appears again in another area of the same document or in another document, the memo created before can be shown.

To accomplish the above object, according to one aspect of the present invention, there is provided a method of sharing a memo between electronic documents performed by a computing system which processes the electronic documents, the method comprising the steps of: selecting at least a part of contents of a first electronic document as a target area for storing the memo; creating a keyword set including at least one keyword representing text of the target area; receiving contents of the memo from a user; and storing the memo created by linking the created keyword set and the contents of the memo in a memo storage.

The step of selecting a target area for storing a memo may include the steps of: determining, when the user specifies a desired area, the area specified by the user as a target area; estimating, when the user does not specify a target area, at least a part of the first electronic document as a target area on the basis of a position of sentences on a screen on which the first document is displayed, a position of a cursor or a pointer, or a position touched last before a memo creation command is inputted from the user; and requesting confirmation of the estimated target area by providing the estimated target area to the user.

The step of selecting a target area for storing a memo may include the steps of: estimating a plurality of text areas as a memo target area from text displayed on a screen among the contents of the first electronic document and from a context or a paragraph, although not displayed on the screen, including the text displayed on the screen; providing the user with an estimated area list showing the plurality of estimated text areas; and determining a text area selected by the user from the estimated area list as a target area.

At the step of creating a keyword set, the user may configure the keyword set by selecting keywords from the target area or creating the keywords by himself or herself.

The step of creating a keyword set may include the steps of: providing, after extracting at least one keyword representing the target area, a user interface for modifying or approving the extracted keywords; and including the keywords modified or approved according to modification or approval of the user through the user interface in the keyword set.

The step of creating a keyword set may include the steps of: extracting at least one keyword representing the target area and assigning a weighting value to each extracted keyword in the keyword set by a natural language processing computer; providing an interface for modifying the weighting value of each keyword in the keyword set by the user; and configuring the keyword set by reflecting the weight value of each keyword modified by the user.

At the step of receiving contents of the memo, text inputted by the user may be determined as the contents of the memo, entire text of the area selected by the user in the first electronic document may be scraped and determined as the contents of the memo, or when the user highlights or underlines the text of the area, the highlighted or underlined text may be recognized and inputted as a memo.

The step of storing the memo may include the step of linking meta information, including at least one of a storage time, an input device, an input location, a document classification and a document format of the memo, to the memo and storing the memo linked to the meta information.

The method of sharing a memo between electronic documents may further comprise the steps of: creating an extended keyword set by additionally extracting a keyword representing an area of an upper unit including the target area for storing the memo; and linking the extended keyword set to the memo and storing the memo.

According to another aspect of the present invention, there is provided a method of sharing a memo between electronic documents performed by a computing system which processes the electronic documents, the method comprising the steps of: selecting at least a part of a second electronic document as a target area for retrieving a related memo; acquiring a keyword set including a keyword representing text of at least one unit area configuring the target area; retrieving a memo having a keyword set, similarity of which to the acquired keyword set is higher than a predetermined value, from a memo storage; and providing the memo retrieved from the memo storage in correspondence to each unit area of the second electronic document.

The step of selecting a target area may include the steps of: selecting an entire second electronic document as a target area when a memo analysis request on the second electronic document is received from a user; and selecting a paragraph or a sub-paragraph including a page or a sentence that the user is currently reading as a target area when the second electronic document is opened on a screen.

The step of acquiring a keyword set may include the steps of: transmitting text of the target area to a natural language processing server; and receiving a keyword set including at least one keyword extracted from the corresponding text for each unit area from the natural language processing server.

The step of retrieving a memo may include the steps of: transmitting the acquired keyword set to a memo storage server; and receiving a memo having a keyword set, similarity of which to the keyword set is higher than a predetermined value, from the memo storage server.

The step of providing the retrieved memo may include the step of informing existence of a memo having a similar keyword set or outputting contents of the corresponding memo, if the user moves to a position where the retrieved memo is found while reading the second electronic document.

The method of sharing a memo between electronic documents may further comprise the step of modifying or deleting a memo of the memo storage if a request for modifying or deleting the provided memo is received from the user.

The memo storage stores contents of a memo, a keyword set and meta information of each memo, and the meta information includes at least one of a storage time, an input device, an input location, a document classification and a document format of a corresponding memo, and the step of retrieving a memo may include the step of limiting a retrieval range according to contents of the meta information when a memo stored in the memo storage is retrieved.

The step of retrieving a memo may include the steps of: providing a user interface for inputting whether or not to extend a keyword desired by the user, among the keywords in the acquired keyword set, to include synonyms, hypernyms and/or hyponyms of the keyword; and changing a condition of similarity retrieval according to input of the user made through the user interface.

### BRIEF DESCRIPTION OF THE DRAWINGS

FIG. 1 is a view showing the network configuration of a system for sharing a memo between electronic documents according to an embodiment of the present invention.

FIG. 2 is a flowchart illustrating a method of storing a memo to share the memo between electronic documents according to an embodiment of the present invention.

FIG. 3 is a view showing the process of storing a memo to share the memo between electronic documents according to an embodiment of the present invention.

FIG. 4 is a view showing the process of correcting, by a user, a keyword created in a specific area of an electronic document according to an embodiment of the present invention.

FIG. 5 is a view showing the process of selecting a keyword by a user from an electronic document when a memo is stored according to an embodiment of the present invention.

FIG. 6 is a view showing the process of creating an extended keyword set when a memo is stored according to an embodiment of the present invention.

FIG. 7 is a flowchart illustrating a method of retrieving and providing a memo to share the memo between electronic documents according to an embodiment of the present invention.

FIG. 8 is an exemplary view showing a screen for retrieving and providing a shared memo according to an embodiment of the present invention.

FIG. 9 is an exemplary view showing a screen for setting a memo link condition according to an embodiment of the present invention.

FIG. 10 is a view showing the process of reflecting a weighting value when similarity between keyword sets is analyzed according to an embodiment of the present invention.

### DESCRIPTION OF SYMBOLS

10: Natural language processing server
11: Memo storage server
12: Memo storage (DB)
13: User terminal

### DETAILED DESCRIPTION OF THE PREFERRED EMBODIMENT

The terms used in this specification will be described briefly, and the present invention will be described in detail.

Although general terms widely used in the present are selected as the terms used in the present invention if possible taking into account the functions of the present invention, this may vary according to the intention of those skilled in the art, precedents or advent of new techniques. In addition, there are terms arbitrarily selected by the inventor in a specific case, and in this case, detailed meanings thereof will be described in corresponding description of the present invention. Accordingly, the terms used in the present invention are not simply names of the terms, but should be defined on the basis of the meanings of the terms and the contents described throughout the present invention.

If a part “includes” a constitutional element throughout this specification, it means further including another constitutional element, not excluding another constitutional element, as far as an opposed description is not specially specified. In addition, the terms such as “. . . means”, “. . . unit”, “. . . module” and the like specified in the specification means a unit of processing at least one function or operation, and this can be implemented in hardware or software or implemented as a combination of hardware and software.

Hereinafter, embodiments of the present invention will be described in detail with reference to the accompanying drawings so that those skilled in the art may easily embody. However, the present invention may be implemented in various different forms and is not limited to the embodiments described herein. In addition, the parts unrelated to the description are omitted to clearly describe the present invention, and like parts will be denoted by like reference numerals throughout the specification.

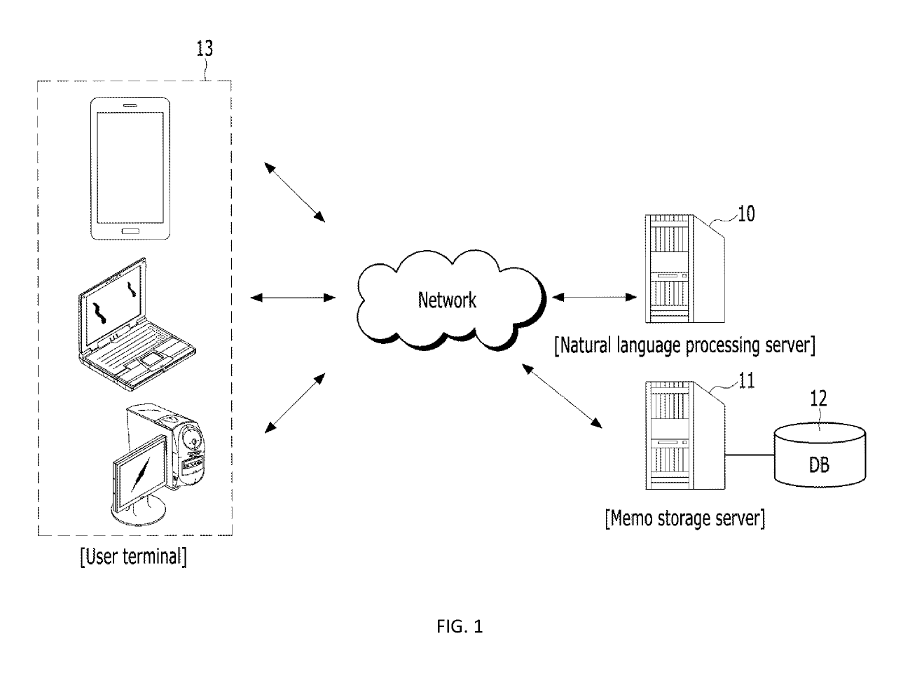

FIG. 1 is a view showing the network configuration of a system for sharing a memo between electronic documents according to an embodiment of the present invention.

Referring to FIG. 1, a system for sharing a memo between electronic documents may include a user terminal 13 for supporting a user to create an electronic document or read a previously stored electronic document, a natural language processing server 10 for communicating with the user terminal 13 through a network such as the Internet or the like, and a memo storage server 11 having a memo storage 12.

The user terminal 12 is a computing system such as a personal computer, a notebook computer, a smart phone or the like, which creates a memo corresponding to a specific area of an electronic document according to input of a user, and retrieves and provides a memo having a keyword set related to a new document that the user is reading or desires to read from the memo storage 12 so that a memo created and stored for another document or another part of the same document may be shared.

The natural language processing server 10 is a computing system for extracting a keyword (keywords) representing contents of a predetermined unit such as a paragraph, a sub-paragraph, a context or the like of text through natural language analysis on text data and creating a keyword set configured of these keywords.

Although it is shown in the embodiment of FIG. 1 that a separate external server 10 communicating with the user terminal 13 through a network performs a natural language processing function, according to embodiments, the user terminal itself may create a keyword set for a specific part of an electronic document if the user terminal 13 is provided with a natural language processing module. That is, it may be implemented to perform the function of the natural language processing server 10 by a local user terminal 13.

The memo storage server 11 links a memo inputted by the user through the user terminal 13 to the keyword set and stores the memo in the memo storage 12, and retrieves and provides a memo having a keyword set related to the contents of an electronic document that the user is currently reading or desires to read from the memo storage 12 when there is a memo share request or a memo retrieval request from the user terminal 13.

Although it is shown in the embodiment of FIG. 1 that the separate memo storage server 11 communicating with the user terminal 13 through a network is provided with a database 12 for storing a shared memo and provides a memo retrieval service, according to embodiments, it may be implemented to include a memo storage DB in the user terminal 13 and retrieve and provide a shared memo by a retrieval module of the user terminal 13. That is, it may be implemented to perform the function of the memo storage server 11 by the user terminal 13.

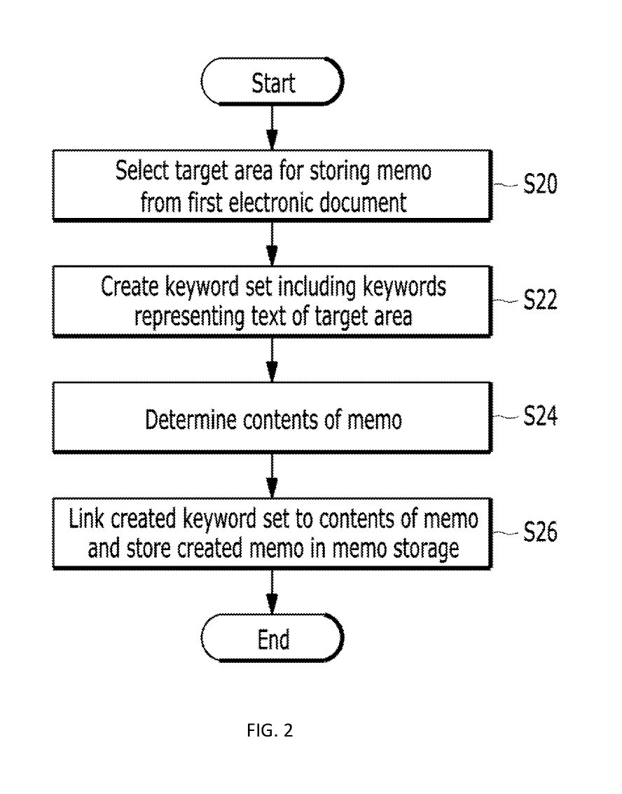

Details of the method of creating and storing a memo of an electronic document and sharing the memo in another electronic document will be described below with reference to FIGS. 2 to 10.

FIG. 2 is a flowchart illustrating a method of storing a memo to share the memo between electronic documents according to an embodiment of the present invention.

First, at least a part of the contents of a first electronic document is selected as a target area for storing a memo (step S20). The target area may be specified according to input of a user or automatically set by the user terminal 13. A memo on the selected target area is created and stored.

The first electronic document is a document that the user opens and uses at the user terminal 13, and generally, the user specifies an area desired to write a memo in an input method such as drag or the like. In this case, the area specified by the user is determined as a target area for storing a memo.

On the other hand, if the user inputs a memo creation command without specifying a target area, a text area for storing a memo may be estimated on the basis of the position of the sentences currently displayed on the display screen.

For example, when a memo storage command is inputted while the cursor or the pointer is placed at a specific position, a memo location range may be estimated by analyzing a range of a context, a sub-paragraph, a paragraph or the like on the basis of the text where the cursor or the pointer is placed.

Alternatively, a range for extracting a keyword may be estimated by analyzing a range of a context or a sub-paragraph on the basis of a sentence placed in the middle of the display.

The target area automatically estimated by the user terminal 13 may be provided to the user and go through a step of requesting confirmation. For example, it may be implemented to highlight the estimated area, inquire the user whether or not to write a memo on the corresponding area, and allow the user to approve or modify the corresponding area.

On the other hand, a plurality of text areas may be estimated as a memo target area from the text displayed on the screen among the contents of the first electronic document and from a paragraph including the text. In this case, an estimated area list showing the plurality of estimated text areas is provided to the user by displaying the list on the screen, and a text area selected by the user from the estimated area list may be determined as a target area.

If a target area is determined, a keyword set including at least one keyword representing the target area is created (step S22). The keyword may be extracted from the text data in the target area through a natural language processing computer. A keyword is also referred to as an index term, a subject term, a subject heading, a descriptor or the like in the information retrieval field. The keyword set may function as a summary of a corresponding memo.

The keyword may include a phrase, in addition to a word. For example, a keyword set [American, politician, lawyer, ‘President of the United States’, ‘federal government’] may be created.

In addition, when a keyword is stored in the keyword set, several different forms of words generated by inflection (e.g., a plural form or change of tense) or derivation (e.g., creating a verb into a noun by attaching a suffix ‘-action’) of a keyword extracted using a stemming algorithm may be reduced to and stored as one common stem. For example, in the case of fish, fishes and fishing, they may be converted into and stored as fish.

At step S24, contents of a memo are received from the user. The user may input text as the contents of a memo by himself or herself or input a memo by selecting part of text display on the screen. The text of a target area for storing a memo may be selected as the contents of the memo.

In addition, when the text of the area is highlighted or underlined, the highlighted or underlined text may be recognized and inputted as a memo.

If contents of a memo to be stored are determined, the memo is created by linking the keyword set created as described above to the contents of the memo, and the created memo is stored in the memo storage (step S26).

The memo stored in the memo storage may be provided to the user in correspondence to another document or a different part of the first electronic document, which is the same document. That is, the memo is provided to a user who desires to use an electronic document having a keyword set of high similarity to a keyword set linked to a previously stored memo to share the memo with the user. A user creating and storing a memo and a user using the shared memo may be the same user or different users.

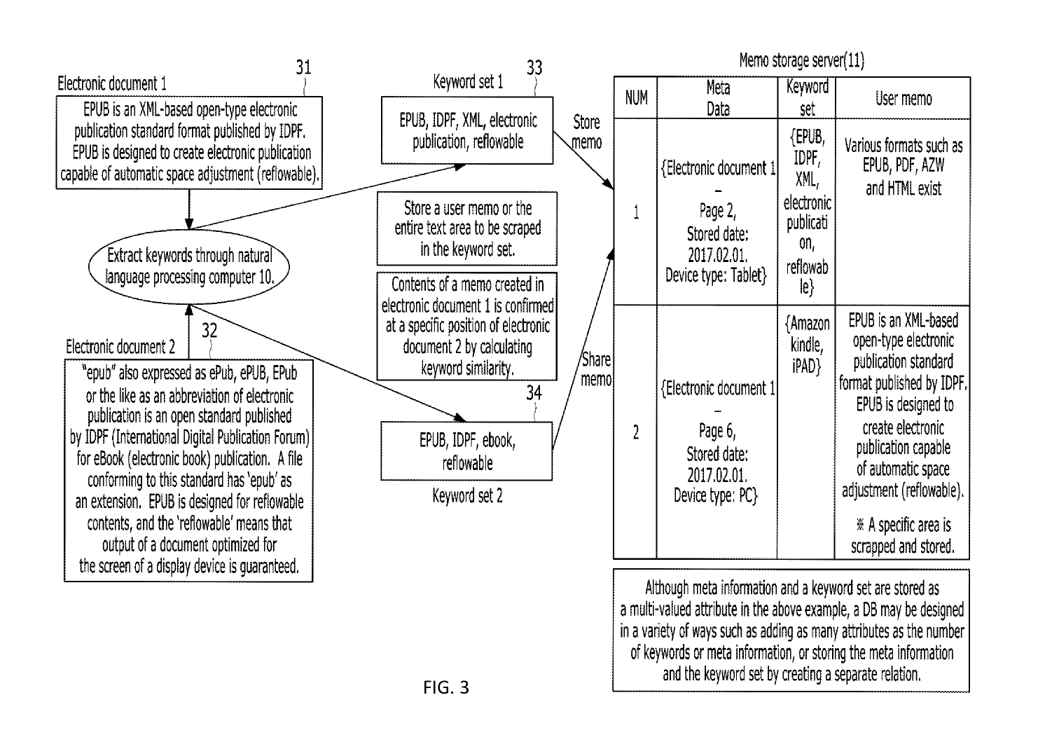

FIG. 3 is a view showing the process of storing a memo to share the memo between electronic documents according to an embodiment of the present invention.

Referring to GIG. 3, it is understood that electronic document 1 is a document that is a memo creation target and a part of the contents is selected as a target area 31 for storing a memo.

The text data included in the target area goes through a natural language process, and one or more keywords are extracted as a result thereof. In the example of FIG. 3, six keywords are extracted from the text of the target area 31, and a keyword set [EPUB, IDPF, XML, electronic publication, reflowable] configured of the extracted keywords is created.

The natural language processing computer may individually assign a weighting value to each keyword when a keyword set is created, and may determine an order of keywords in the keyword set according to the priority of each keyword.

Seeing FIG. 3, keyword set 1 33 [EPUB, IDPF, XML, electronic publication, reflowable] may express that EPUB is a first priority keyword, IDPF is a second priority keyword, XML is a third priority keyword, electronic publication is a fourth priority keyword, and reflowable is a fifth priority keyword.

In addition, a weighting value may be set and stored for each individual keyword like [EPUB#2, IDPF#5, XML#6, electronic publication#6, reflowable#8] (a numeral after delimiter # indicates a weighting value).

In addition, a user himself or herself may assign a weighting value to each created keyword, or it is possible to provide an interface for modifying a weighting value automatically assigned by the natural language computer and receive an input from the user to set a weighting value of each keyword in a keyword set.

The created keyword set is stored in the storage of the memo storage server 11, and at this point, the keyword set and the memo inputted by the user are linked to each other and stored in the storage.

In the example of FIG. 3, it is understood that contents of the memo ‘there exist various formats such as EPUB, PDF, AZW, HTML and the like’ are linked to keyword set 1 33 [EPUB, IDPF, XML, electronic publication, reflowable] and stored as memo #1.

In addition, meta information including information on the memo may be stored together when the memo is stored. In the example of FIG. 3, it is understood that “electronic document 1” which is identification information of a document that is a target for storing a memo, “Page 2” which is information for identifying a target area, “Feb. 01, 2017” which is the date of storing the memo, and “tablet” which is a type of a device used for storing the memo are stored as meta information of memo #1.

Memo #2 is a memo stored for another page of “electronic document 1”, which is the same document, and this is a case of selecting a specific area of the same document and setting the area as contents of the memo, instead of inputting text to be stored as contents of the memo by the user. That is, the user may select a desired part from a document displayed on the screen, scrap the entire text of the selected area, and input the scraped text as the contents of the memo.

On the other hand, if the user desires to read a specific area 32 of electronic document 2, a natural language process is performed on the text data included in the area, and one or more keywords are extracted as a result thereof. In the example of FIG. 3, it is understood that keyword set 2 34 created for the specific area 32 of electronic document 2 is [EPUB, IDPF, ebook, reflowable] including four keywords.

The created keyword set 2 34 is transmitted to the memo storage server 11, and similarity to the keyword sets of memos stored in the memo storage server 11 is calculated. As a result thereof, a memo having a keyword set of high similarity to the keyword set 2 34 is retrieved, and contents of the retrieved memo #1 is provided to and shared with a user reading the electronic document 2.

Accordingly, a user using the electronic document 2 may see a memo related to the contents of the electronic document 2 among the memos created and stored for other documents.

The meta information linked to the memo contents and stored together with the keyword set may include various information on a corresponding document such as a time and a place of storing the memo, decimal classification information (Korean decimal classification, Dewey decimal classification or the like) of a book, a file type (html, pdf, MS Word or the like), an author, a device (a cellular phone, a notebook computer or a tablet computer) used for storing the memo, a document type (a blog document, an electronic book, a newspaper or the like) and the like.

For example, if the metadata is stored in a Dublin Core metadata scheme, which is an international standard for describing essential features of an electronic document and providing compatibility among metadata formats, fifteen elements {Title, Creator, Subject, Description, Publisher, Contributor, Data, Type, Format, Identifier, Source, Language, Relation, Coverage, Right} of the metadata may be stored.

In the example, when whether or not to output a memo stored in a keyword set is determined through comparison of the keyword set of the target area 31 those of other electronic documents, a conditional retrieval may be performed by specifying a time and a place of recording the memo, classification of a document or the like. As a result, when a keyword set in which the keywords extracted from a new document are included is compared with a keyword set of the memo storage DB 12, a range of the comparison may be confined according to the meta information.

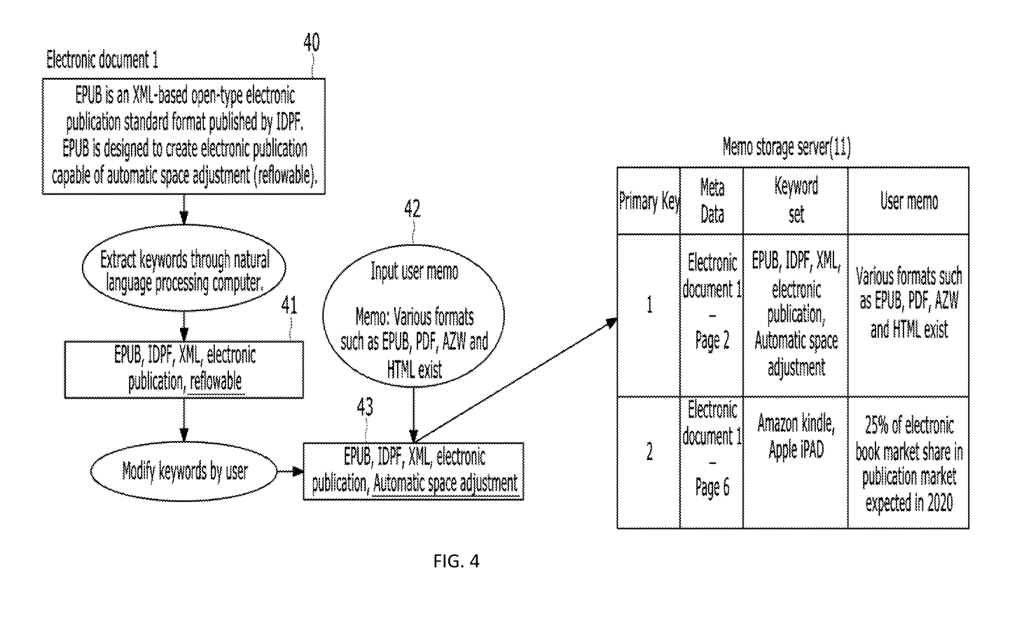

FIG. 4 is a view showing the process of correcting, by a user, a keyword created in a specific area of an electronic document according to an embodiment of the present invention.

When a user is going to create a memo on a target area 40 of electronic document 1, the user terminal 13 or the natural language processing server 10 creates a keyword set 41 by extracting keywords that may represent the contents of the target area 40 through natural language processing.

At this point, the extracted keywords are shown to the user so that the user may modify the keywords.

Specifically, after extracting at least one keyword representing the target area 40, a user interface for modifying or approving the extracted keywords is provided, and the keywords modified or approved according to modification or approval of the user through the user interface may be included in the keyword set. The user may modify or delete automatically extracted keywords or add new keywords through the interface.

Referring to FIG. 4, it is understood that ‘reflowable’ among the automatically created keywords is changed to ‘automatic space adjustment’ by the user, and the contents 42 of the memo inputted by the user and the changed keyword set 43 are linked to each other and stored as memo #1 (a memo having a primary key of 1).

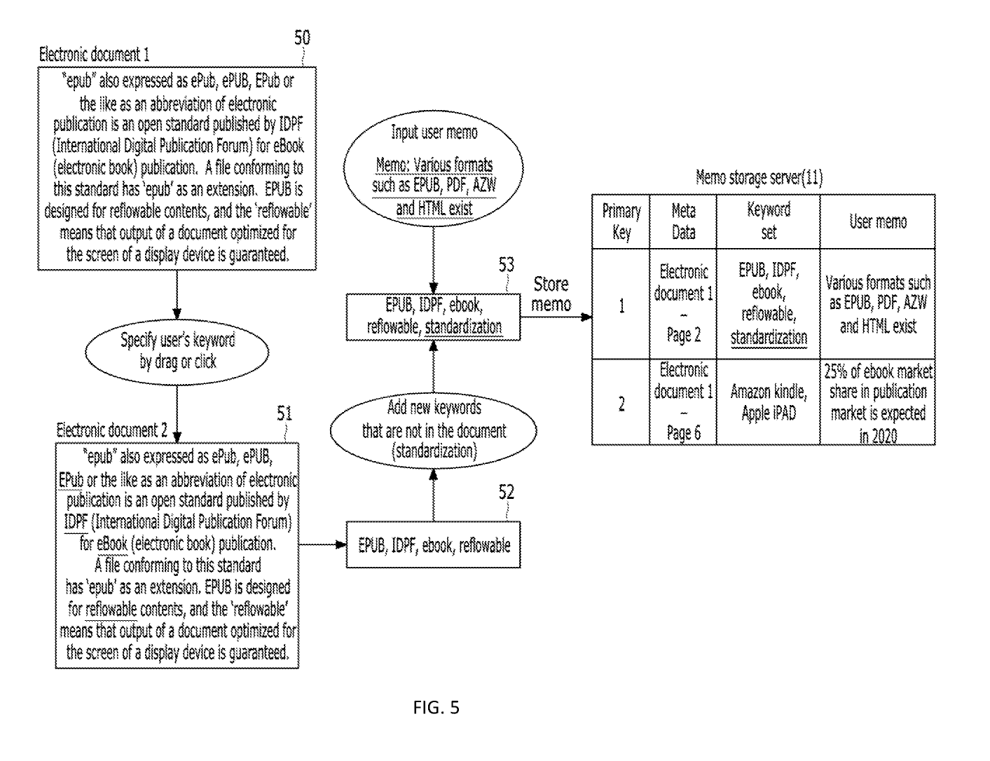

FIG. 5 is a view showing the process of selecting a keyword by a user from an electronic document when a memo is stored according to an embodiment of the present invention.

In the embodiment shown in FIG. 5, keywords to be linked to a memo and stored are selected by the user. A target area 50 for creating a memo is determined, and words or phrases selected from the target area 50 by the user are included in the keyword set. Keywords EPUB, IDPF, ebook and reflowable selected by the user are included in the keyword set 52, and furthermore, words or phrases not included in the target area may be selected as keywords and additionally included in the keyword set 53 through natural language processing. The added keywords may be extracted by analyzing a memo target area, a paragraph including the memo target area, entire contents of the document or the like.

Referring to FIG. 5, it is understood that the keyword set 53 finally created as described above is linked to the contents of the memo inputted by the user and stored as memo #1 (a memo having a primary key of 1).

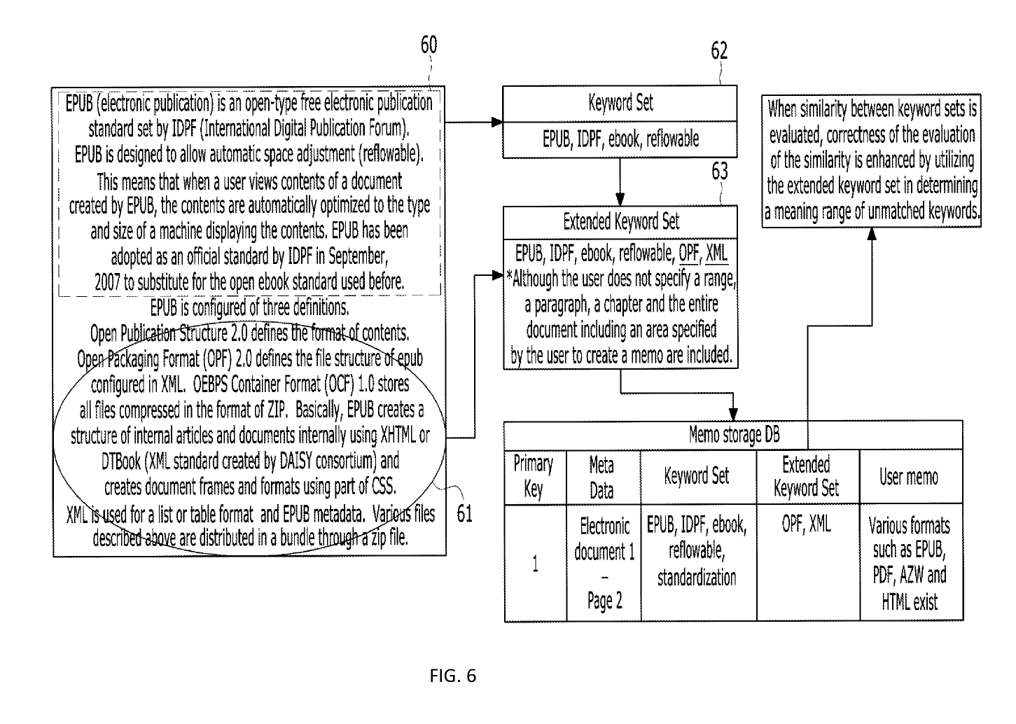

FIG. 6 is a view showing the process of creating an extended keyword set when a memo is stored according to an embodiment of the present invention.

In addition to the keyword set including the keywords extracted from the target area when a keyword set of a memo that is currently being created is created, an extended keyword set may be created by additionally extracting keywords that may represent an area of an upper unit including the target area. Specifically, the extended keyword set may be created by extracting keywords representing a paragraph or a chapter including the target area or the entire document and stored together when the memo is stored.

Referring to FIG. 6, it is understood that as a user specifies an area for creating a memo, a target area 60 for storing the memo is determined, and [EPUB, IDPF, ebook, reflowable] is created as a set 62 of keywords representing the contents of the target area 60. In addition, it is understood that keywords such as OFL and XML are additionally included in the extended keyword set 63 including keywords extracted by considering the areas 61 other than the target area 60 as a target of natural language processing.

Like the keyword set 62, a user interface for outputting the keywords of the extended keyword set 63 on the screen to present the keywords to the user and modifying or deleting keywords according to the intention of the user may be provided.

The keyword (keywords) added to the extended keyword set will be linked to the contents of the memo and stored together and may be used for calculating similarity when a shared memo is retrieved. Correctness of the evaluation of the similarity may be enhanced by utilizing the keywords added to the extended keyword set in determining a meaning range of unmatched keywords when similarity between keyword sets is evaluated.

If a keyword created from a text area of a stored memo is a generally and frequently used word or a keyword that does not characterize the entire contents of the document, a document field is classified (clustering) through the keywords stored in the extended keyword set, and stored keyword sets are compared with each other in the corresponding field.

TABLE 1

| | |
|---|---|
| Original document (a | The ideas of using a computer to retrieve |
| text area specified to | information has been generalized through |
| store a memo or a text | ‘As We May Think’ contributed to The |
| area specified to scrap) | Atlantic by Vannevar Bush in 1945. [2] The |
| | first automated information retrieval |
| | system was adopted in 1950s to 1960s. |
| | Several methods targeting small-scale |
| | corpuses, such as Cranfield collection, |
| | which is a collection of several thousands |
| | of documents, was introduced in the |
| | academic world until 1970. [2] A large-scale |
| | retrieval system, such as Lockheed Dialog |
| | system, has been used from early 1970s. |
| Keyword set | Information, Computer, Retrieval, System |
| Extended Keyword set | Data set, Index, Ranking, Boolean, Vector |

Seeing table 1, although a keyword set in which the keywords extracted from an original document are included includes keywords representing a corresponding text area, the field of the contents contained in the corresponding keyword set is unknown when the keyword set is compared with another keyword set, and therefore, there may be a problem of wrongly matching the keyword set to a keyword set of an irrelevant field when similarity between keyword sets is evaluated.

As a specific example, although the original document of Table 1 is scraped in the information retrieval field, if the rate of matching to keywords extracted from a text area covering information society in a humanities book is high, there may be a mismatching.

To prevent such a problem, keywords representatively extracted from a paragraph or the entire document, as well as the keywords extracted from a target area determined to store a memo, are stored in the extended keyword set and used when similarity between keyword sets is evaluated.

As a method of retrieving a memo stored in the memo storage DB 12, an interface for inputting a keyword retrieval condition may be provided to the user. If the user inputs one or more keywords together with Boolean logic operators (AND, OR, NOT) through the interface, a memo may be outputted by retrieving a keyword set in the memo storage DB 12 using the inputted keyword retrieval condition.

In addition, there is provided a user interface for inputting whether or not to extend a keyword desired by the user, among the keywords in the keyword set, to include synonyms, hypernyms and/or hyponyms of the keyword, and the condition of similarity retrieval may be changed according to input of the user made through the user interface.

In addition, when a stored memo is retrieved, a memo stored in a keyword set may be retrieved by automatically converting the keyword of the retrieval condition received from the user into a synonym, a hypernym, a hyponym or the like.

For example, it is assumed that a keyword set of a previously stored memo is [Sunshin Lee, Hansan-do, Great victory, Japan, Chosen, 25-th year of Seonjo]. When a user inputs a keyword retrieval condition of ‘Sunshin Lee & Year 1592’ when the user retrieves a keyword, the memo cannot be retrieved if the retrieval condition is used as is. However, if the keyword ‘Year 1592’ is converted into a synonym and the synonym is used, the memo previously stored in the keyword set [Sunshin Lee, Hansan-do, Great victory, Japan, Chosen, 25-th year of Seonjo] can be retrieved.

As described above, if a user (users) creates a memo while using an electronic document, a memo including contents, a keyword set and meta information of the memo is created and stored in a storage different from the storage of the target document.

The memos accumulated in the storage like this may be retrieved and provided during or before the same user or another user reads a second electronic document, which is another electronic document. According to this, although there is no memo created for the second electronic document, a memo stored for the first electronic document containing related or similar contents is retrieved and shared.

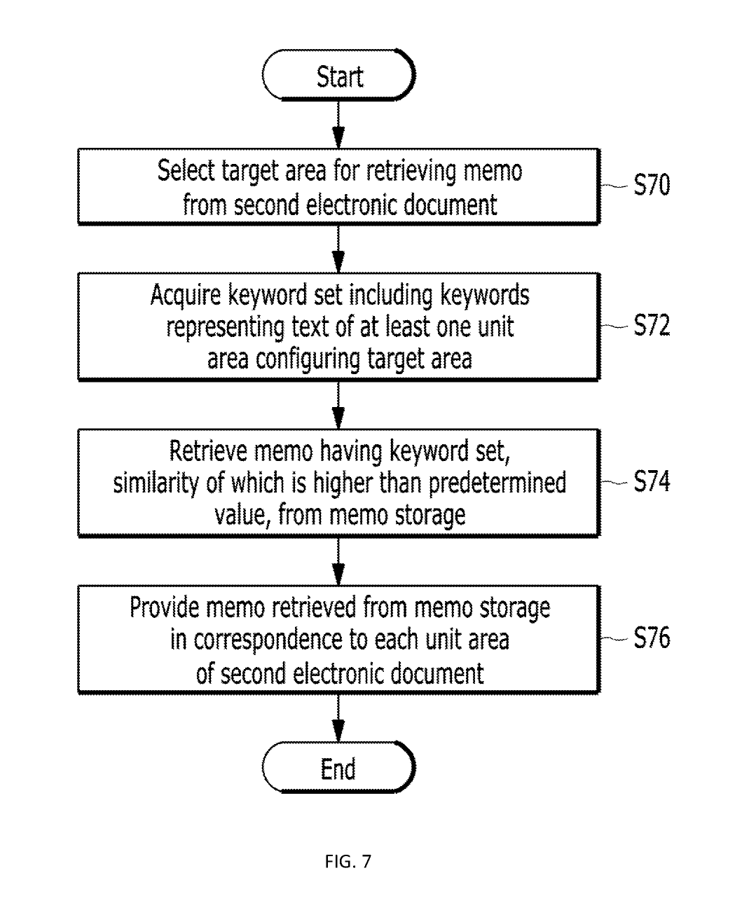

FIG. 7 is a flowchart illustrating a method of retrieving and providing a memo to share the memo between electronic documents according to an embodiment of the present invention.

The second electronic document is an electronic document that a user is going to read or is reading. At step S70, at least a part of the second electronic document is selected as a target area for retrieving a related memo.

When a memo analysis request for the second electronic document is received from the user, the entire second electronic document is selected as an analysis target area. This is a case in which the user desires to retrieve a memo related to the corresponding document before reading a new document.

According to embodiments, when a request for reading the second electronic document is received from the user, i.e., the user desires to read the second electronic document, the entire document may be analyzed to retrieve and provide a related memo by creating a keyword set of each chapter, paragraph, sub-paragraph and context for the entire second electronic document and evaluating similarity between the corresponding keyword set and keyword sets stored in the memo storage.

On the other hand, if the second electronic document is opened on the screen, a paragraph or a sub-paragraph including a page or a sentence that the user is currently reading may be selected as a retrieval target area. In this case, while the user reads the second electronic document, analysis on a part that the user is reading is automatically performed, and a related memo can be shown.

If a retrieval target area is determined, a keyword set including a keyword representing text of at least one unit area configuring the retrieval target area is acquired (step S72).

To this end, the text of the retrieval target area is transmitted to the natural language processing server 10. The natural language processing server 10 divides the text of the retrieval target area into one or more unit areas. The unit area may be a sentence, a context, a sub-paragraph, a paragraph, a chapter or the entire document, and division into the unit areas may be performed according to the setting of the user or the configuration of the retrieval target document. The natural language processing server 10 creates a set of keywords representing contents of corresponding text for each unit area.

If a keyword set including at least one keyword extracted from corresponding text for each unit area is received from the natural language processing server 10, a memo having a keyword set, the similarity of which to the received keyword set is higher than a predetermined value, is retrieved from the memo storage 12 (step S74).

Specifically, the keyword set acquired for the second electronic document is transmitted to the memo storage server 11, and a memo having a keyword set, the similarity of which is higher than a predetermined value, is received from the memo storage server 11.

Not only a memo stored for a document other than the second electronic document becomes a target of retrieval, but also a memo stored for another area of the second electronic document may be a target of retrieval. That is, contents of a memo created for a specific area of an electronic document may be shown (shared) in another area of the same electronic document or in another electronic document.

Measuring the similarity between keyword sets utilizes various methodologies used in the information retrieval field, and typically, a Boolean model, a vector space model, a fuzzy set model and the like may be utilized. However, since descriptions on the various methodologies and detailed algorithms for evaluating the similarity between keyword sets are not the gist of the present invention, they will be omitted.

When similarity between keyword sets is evaluated, if a keyword in a keyword set is determined to correspond to a hypernym, a hyponym or a synonym through an analysis on the thesaurus of the keywords in the keyword set, the keyword may be taken into account when the similarity is evaluated. For example, since a hyponym of ‘person’ may be ‘Sunshin Lee’, ‘Gildong Hong’, ‘Socrates’ or the like and a hypernym of ‘Sunshin Lee’, ‘Gildong Hong’ or ‘Socrates’ may be ‘person’, it may be determined that both of them are similar to each other when the similarity is evaluated.

At step S76, a memo retrieved from the memo storage 12 in correspondence to each unit area of the second electronic document is provided.

If the user is reading the second electronic document, a memo having a keyword set of high similarity to the keyword set of a sentence, a context, a sub-paragraph, a paragraph or a chapter that the user is reading is retrieved and informed to the user in real-time. Since the retrieval is automatically performed while the user reads the second electronic document, if the user moves to the position where the retrieved memo is found, existence of a memo having a similar keyword set is informed, or contents of the corresponding memo is outputted.

If it is before the user reads the second electronic document, a memo having a keyword set of high similarity may be provided among the memos previously accumulated for each unit area of the second electronic document, and an estimated interest of the user in a new document may be informed by calculating similarity to the keyword sets of the memos previously accumulated for each unit area of the new document.

For example, if a memo is stored in a keyword set having high similarity to the keyword set of a paragraph or sub-paragraph unit of the second electronic document, it may be estimated that interest of the user in the specific part of the corresponding document is high.

Accordingly, the user may determine in advance whether a corresponding document contains information that the user desires before the user reads the document.

A user interface allowing the user to modify or delete a shared memo retrieved and provided for the second electronic document may be provided, and when the user modifies or deletes a shared memo, memo information of the memo storage 12 is modified or deleted. Accordingly, when a memo shown in the second electronic document is modified, the modified memo may be shown in the first electronic document for which the corresponding memo has been created.

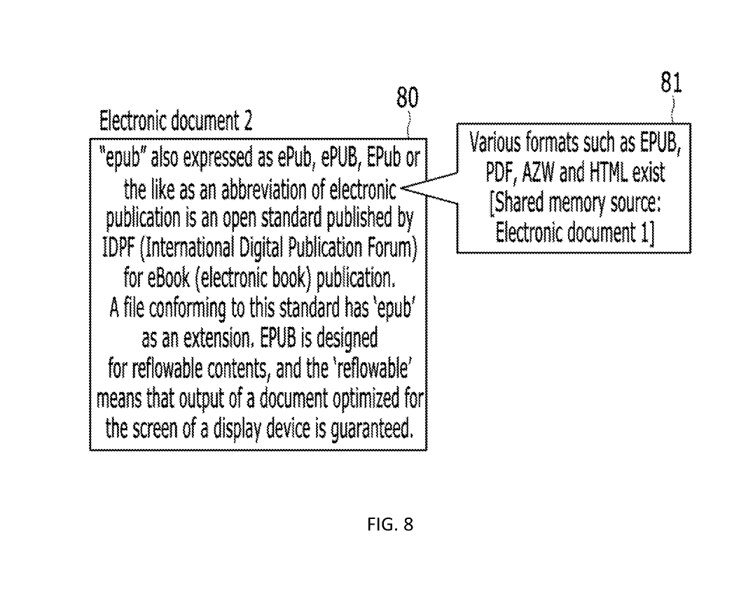

FIG. 8 is an exemplary view showing a screen for retrieving and providing a shared memo according to an embodiment of the present invention.

Referring to FIG. 8, it is understood that a user reads a specific area 80 of the second electronic document, and a memo 81 having a keyword set of high similarity to a keyword set in which the keywords extracted from the corresponding area are included is retrieved from the memo storage DB 12 and automatically provided. The user may see a memo of the first electronic document, which is another electronic document containing similar contents, while viewing the second electronic document.

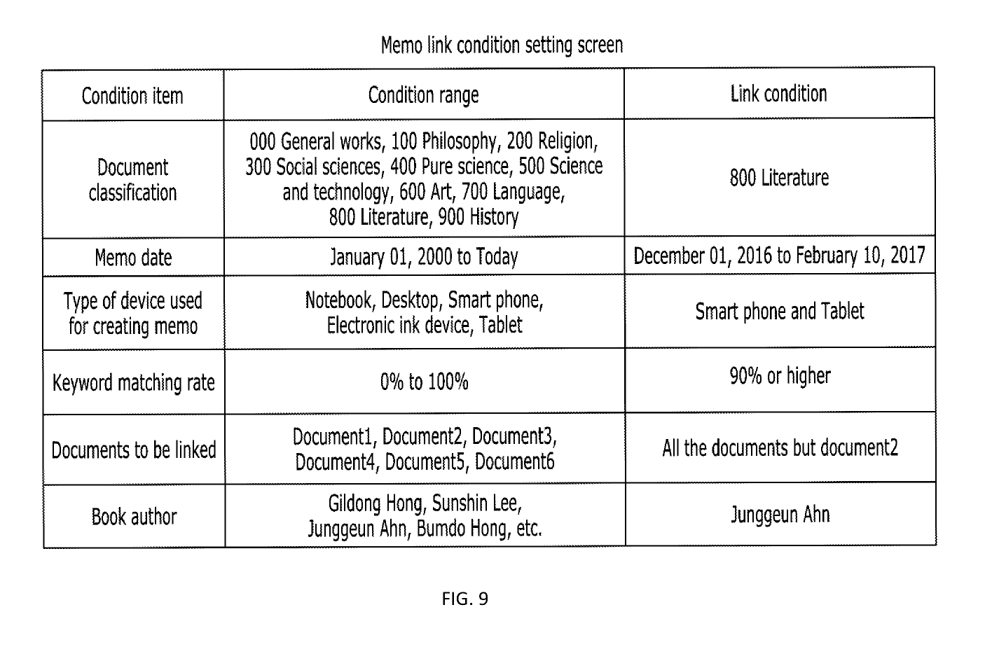

FIG. 9 is an exemplary view showing a screen for setting a memo link condition according to an embodiment of the present invention.

When retrieving a previously stored memo, a user may set a memo link condition to limit the retrieval range, and meta information of the memo and points of similarity between keyword sets are used for the retrieval performed under the condition. Referring to FIG. 9, it is set to retrieve a memo only for the documents excluding document 2 on condition that a document classification is 800 literature, a memo input date is between Dec. 1, 2016 and Feb. 10, 2017, a device used for memo input is a smart phone or a tablet computer, and a keyword matching rate is 90% or higher, and to retrieve the memo by limiting the range to a case in which the author is Junggeun Ahn.

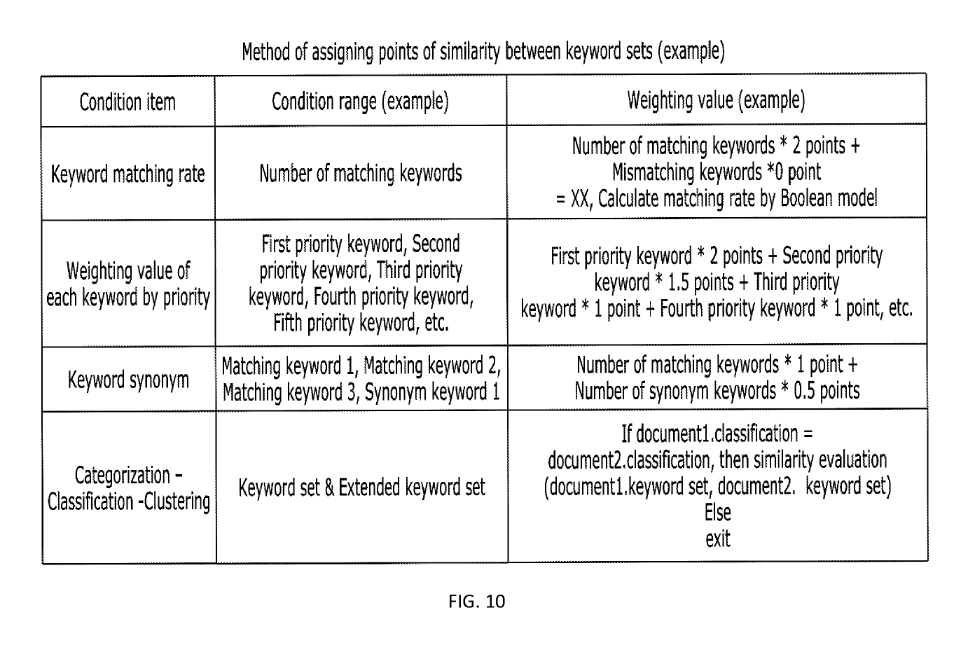

FIG. 10 is a view showing the process of reflecting a weighting value when similarity between keyword sets is analyzed according to an embodiment of the present invention.

In calculating the similarity points for evaluation of similarity between keyword sets, weighting values are applied according to the number of matching keywords, and a different weighting value is assigned according to the priority of a matching keyword. A different weighting value is assigned when a keyword matches and when the keyword is a synonym, and a different weighting value may be assigned to the similarity to a keyword set and to the similarity to an extended keyword set.

Alternatively, a document field may be clustered through the extended keyword set, and a range of evaluating the similarity between keyword sets may be limited to the same cluster category.

The method according to an embodiment of the present invention may be implemented in the form of a program command that can be performed through various computer means and may be recorded in a computer-readable medium. The computer-readable medium may include program commands, data files, data structures and the like individually or in combination. The program commands recorded in the medium may be commands specially designed and configured for the present invention or commands publicized and used by those skilled in the art of computer software. Examples of the computer-readable recording medium include magnetic media such as a hard disk, a floppy disk and a magnetic tape, optical media such as CD-ROM and DVD, magneto-optical media such as a floptical disk, and hardware devices specially configured to store and perform the program commands, such as ROM, RAM, flash memory and the like. Examples of the program commands include a high-level language code that can be executed by a computer using an interpreter or the like, as well as a machine language code produced by a compiler.

According to the present invention, when a memo is created in a specific area of a specific electronic document, a keyword set is configured by extracting keywords from a corresponding area, and a user memo is stored in a corresponding keyword set, and if the keyword set has high similarity to a keyword set in which the keywords extracted from a paragraph, a sub-paragraph, a context or the like of another document are included, contents of a memo previously stored in the keyword set may be shown in another document.

In addition, according to the present invention, when a memo is created in a specific area of an electronic document, contents of a previously stored memo may be shown in another area of the same document.

In addition, according to the present invention, since a user may see a memo stored in a keyword set of another document having high similarity to a keyword set of a corresponding document before reading a new document, the user may see in advance the contents contained in the new document.

In addition, according to the present invention, since keywords representatively extracted from a paragraph, which is an upper unit, or the entire document, as well as the keywords extracted from a target area determined to store a memo, are stored in an extended keyword set and used when similarity between keyword sets is evaluated, efficiency of analyzing the similarity can be enhanced.

While the embodiments of the present invention have been described above in detail, the scope of the present invention is not limited thereto, and various modified and improved forms made by those skilled in the art using basic concepts of the present invention defined in the appended claims also fall within the scope of the present invention.

What is claimed is:

1. A method of sharing a memo between electronic documents performed by a computing system which processes the electronic documents, the method comprising the steps of:
selecting at least a part of contents of a first electronic document as a target area for storing the memo;
creating a keyword set including at least one keyword representing text of the target area;
receiving contents of the memo from a user; and
storing the memo created by linking the created keyword set and the contents of the memo in a memo storage, wherein
the step of creating a keyword set includes the steps of:
providing, after extracting at least one keyword representing the target area, a user interface for modifying or approving the extracted keywords; and
including the keywords modified or approved according to modification or approval of the user through the user interface in the keyword set.

2. The method according to claim 1, wherein the step of selecting a target area for storing a memo includes the steps of:
determining, when the user specifies a desired area, the area specified by the user as a target area;
estimating, when the user does not specify a target area, at least a part of the first electronic document as a target area on the basis of a position of sentences on a screen on which the first document is displayed, a position of a cursor or a pointer, or a position touched last before a memo creation command is inputted from the user; and
requesting confirmation of the estimated target area by providing the estimated target area to the user.

3. The method according to claim 1, wherein the step of selecting a target area for storing a memo includes the steps of:
estimating a plurality of text areas as a memo target area from text displayed on a screen among the contents of the first electronic document and from a context or a paragraph, although not displayed on the screen, including the text displayed on the screen;
providing the user with an estimated area list showing the plurality of estimated text areas; and
determining a text area selected by the user from the estimated area list as a target area.

4. The method according to claim 1, wherein at the step of creating a keyword set, the user configures the keyword set by selecting keywords from the target area or creating the keywords by himself or herself.

5. The method according to claim 1, wherein the step of creating a keyword set includes the steps of:
extracting at least one keyword representing the target area and assigning a weighting value to each extracted keyword in the keyword set by a natural language processing computer;
providing an interface for modifying the weighting value of each keyword in the keyword set by the user; and
configuring the keyword set by reflecting the weight value of each keyword modified by the user.

6. The method according to claim 1, wherein at the step of receiving contents of the memo,
text inputted by the user is determined as the contents of the memo,
entire text of the area selected by the user in the first electronic document is scraped and determined as the contents of the memo, or
when the user highlights or underlines the text of the area, the highlighted or underlined text is recognized and inputted as a memo.

7. The method according to claim 1, wherein the step of storing the memo includes the step of linking meta information, including at least one of a storage time, an input device, an input location, a document classification and a document format of the memo, to the memo and storing the memo linked to the meta information.

8. The method according to claim 1, further comprising the steps of:
creating an extended keyword set by additionally extracting a keyword representing an area of an upper unit including the target area for storing the memo; and
linking the extended keyword set to the memo and storing the memo.

9. A method of sharing a memo between electronic documents performed by a computing system which processes the electronic documents, the method comprising the steps of:
selecting at least a part of a second electronic document as a target area for retrieving a related memo;
acquiring a keyword set including a keyword representing text of at least one unit area configuring the target area;
retrieving a memo having a keyword set, similarity of which to the acquired keyword set is higher than a predetermined value, from a memo storage; and
providing the memo retrieved from the memo storage in correspondence to each unit area of the second electronic document, wherein
the step of selecting a target area includes the steps of:
selecting an entire second electronic document as a target area when a memo analysis request on the second electronic document is received from a user; and
selecting a paragraph or a sub-paragraph including a page or a sentence that the user is currently reading as a target area when the second electronic document is opened on a screen.

10. The method according to claim 9, wherein the step of acquiring a keyword set includes the steps of:
transmitting text of the target area to a natural language processing server; and
receiving a keyword set including at least one keyword extracted from the corresponding text for each unit area from the natural language processing server.

11. The method according to claim 9, wherein the step of retrieving a memo includes the steps of:
transmitting the acquired keyword set to a memo storage server; and
receiving a memo having a keyword set, similarity of which to the keyword set is higher than a predetermined value, from the memo storage server.

12. The method according to claim 9, wherein the step of providing the retrieved memo includes the step of informing existence of a memo having a similar keyword set or outputting contents of the corresponding memo, if the user moves to a position where the retrieved memo is found while reading the second electronic document.

13. The method according to claim 12, further comprising the step of modifying or deleting a memo of the memo storage if a request for modifying or deleting the provided memo is received from the user.

14. The method according to claim 12, wherein the memo storage stores contents of a memo, a keyword set and meta information of each memo, and the meta information includes at least one of a storage time, an input device, an input location, a document classification and a document format of a corresponding memo, and the step of retrieving a memo includes the step of limiting a retrieval range according to contents of the meta information when a memo stored in the memo storage is retrieved.

15. The method according to claim 12, wherein the step of retrieving a memo includes the steps of:
providing a user interface for inputting whether or not to extend a keyword desired by the user, among the keywords in the acquired keyword set, to include synonyms, hypernyms and/or hyponyms of the keyword; and
changing a condition of similarity retrieval according to input of the user made through the user interface.
